(19) United States
(12) Patent Application Publication
(10) Pub. No.: US 2025/0076957 A1
(43) Pub. Date: Mar. 6, 2025

(54) Watchdog Device Interrupter

(71) Applicant: Detection Innovation Group, Inc., New Port Richey, FL (US)

(72) Inventors: David Segal, Palm Harbor, FL (US); Chris Defant, New Port Richey, FL (US)

(73) Assignee: Detection Innovation Group, Inc., New Port Richey, FL (US)

(21) Appl. No.: 18/458,221

(22) Filed: Aug. 30, 2023

(51) Int. Cl. G06F 1/30; G06F 1/24

(52) U.S. Cl. CPC G06F 1/305; G06F 1/24

(57) ABSTRACT

A system and method of monitoring and resetting a protected device includes sensing a current flowing to a protected device over a time period and comparing the current flowing to the protected device over the time period. When the current flowing to the protected device over the time period differs from an expected power profile for the protected device, power going to the protected device is interrupted for an interval.

### BACKGROUND OF THE INVENTION

Many devices, particularly those that employ a processor and software, experience lockup conditions in which the processor winds up in a state in which it no longer responds to inputs. This often occurs due to an unexpected sequence of inputs that are not expected by the software, perhaps causing the software to return from an interrupt without re-enabling interrupts and, therefore, future inputs that are interrupt driven are not processed resulting in a lockup condition for the device. Note that many other types of lockup conditions for various devices are anticipated as this is but an example of such.

Most modern microprocessors have a built-in watch-dog timer that can reset the processor if the software ever freezes or gets into a state where it is unable to restart the timer. A typical watchdog timer operates through a countdown mechanism, initialized from a set value down to zero. The embedded software is responsible for both selecting the initial value of the counter and routinely refreshing it. Should the counter reach zero prior to a software refresh, the processor's reset signal is triggered. This results in the processor and its embedded software being rebooted, replicating the act of a human operator power cycling the system.

In the event that the software application perceives itself to be functioning within normal parameters, yet crucial variables are compromised, causing the application to deviate from its intended behavior, there's a possibility that the watchdog timer continues to be reset. This situation could reflect suboptimal performance despite the appearance of regular watchdog resets. Today, when many devices lock up they are typically power cycled to reset, using a power switch or unplugging the device from power and re-plugging the device into power. This works for devices that are easily accessible such as a home Wi-Fi router where a power switch or power connection is often readily accessible, but some devices are difficult to access or are powered locally by a battery or a solar panel and the connection between the device and the battery and/or solar panel must be broken to reset the device. For example, a device in a remote location that monitors an array of solar panels and periodically transmits information to a central location. When such a device locks up, this device typically receives power from the solar panels and, therefore, requires a person to travel to the solar panel array, find the device, and disconnect the device from the solar array. In another example, a device is being used in a tradeshow or advertising event and is buried in a cabinet with many other devices. Not only is it difficult to access this device, but it is also difficult to determine which device (out of many) has locked up.

In the past, internal or external current limiters or fuses disconnect power to the device when the device consumes too much power as when a component of the device fails causing the device to consume this much power. Such fuses or circuit breakers only disconnect the device from power and do not automatically reconnect power after a pre-determined amount of time. Often, when a device locks up, the power consumption does not exceed the maximum power consumption expected for such a device and, often, may consume less power or a constant amount of power that is higher than an amount of power consumed during idle periods and less than a maximum power consumption (e.g., flat-lined)

What is needed is a system that will have knowledge of a protected device's expected power usage profile and interrupt power to that device when that device's power usage doesn't follow the expected power usage profile.

### SUMMARY OF THE INVENTION

A system or apparatus has knowledge (or learns) of a device's expected power usage profile (e.g., power usage over a certain time period). The system/apparatus monitors the device's power usage over time and when the device's power usage over time veers from the device's expected power usage profile, power to that device is interrupted for a pre-determined time period, resetting the device. The system/apparatus is either programmed with the device's expected power usage profile or learns the device's expected power usage profile. For example, with a device that has a power usage profile that is typically 10 mA but hourly the device consumes 1.5 A (e.g., when transmitting), if the power usage of the device raises to 0.5 A continuously or stays at 10 mA, the device is reset by disconnecting power to the device for a period of time sufficient for the device's power supply to drain and allow for a complete reset.

In one embodiment, a watchdog device interrupter is disclosed including a controller. A device for sensing a current flowing to a protected device is interfaced to the controller, reporting the current flowing to a protected device to the controller. A device for interrupting power to the protected device is controlled by the controller. An expected power profile of the protected device is interfaced to the controller. The controller monitors the current flowing to the protected device over a period of time and when the current flowing to the protected device over the period of time differs from the expected power profile, the controller controls the device for interrupting power to interrupt power to the protected device for an interval.

In another embodiment, a method of monitoring and resetting a protected device is disclosed including sensing a current flowing to a protected device over a time period and comparing the current flowing to the protected device over the time period. When the current flowing to the protected device over the time period differs from an expected power profile for the protected device, power going to the protected device is interrupted for an interval.

In another embodiment, a system for monitoring and resetting a protected device is disclosed including a processor having a memory. A current sensing device is interfaced to the processor. The current sensing device measures current flowing to a protected device and provides the current measurement to the processor. A power switch is controlled by the processor. The power switch controls a flow of power to the protected device. An expected power profile of the expected device is stored in the memory. Software running on the processor causes the processor to monitor the current flowing to the protected device over a period of time and when the current flowing to the protected device over the period of time differs from the expected power profile, the software running on the processor causes the processor to interrupt power to the protected device.

### BRIEF DESCRIPTION OF DRAWINGS

The invention can be best understood by those having ordinary skill in the art by reference to the following detailed description when considered in conjunction with the accompanying drawings in which:

FIG. 1 illustrates a schematic view of electronic fuse/breaker of the prior art.

FIG. 2 illustrates a schematic view of an embodiment of the watchdog device interrupter.

FIG. 3 illustrates a schematic view of an embodiment of the watchdog device interrupter with a radio frequency receiver/transceiver.

FIG. 4 illustrates a schematic view of another embodiment of the watchdog device interrupter.

FIG. 5 illustrates a block diagram of an embodiment of the watchdog device interrupter with learning.

FIG. 6 illustrates a device's current measurement over time showing the operation of an embodiment of the watchdog device interrupter with learning.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

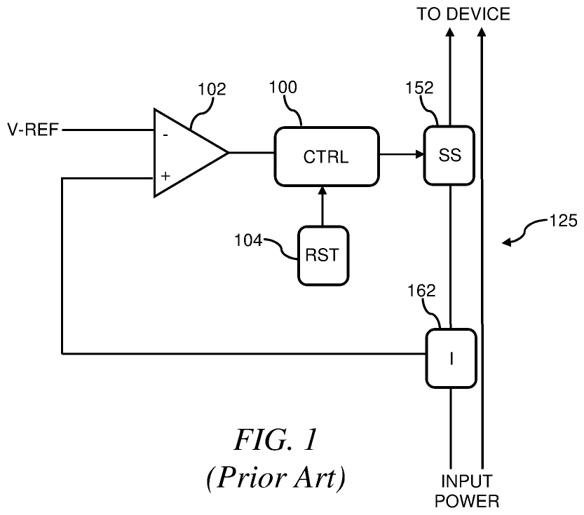

Referring to FIG. 1 illustrates a schematic view of electronic fuse/breaker of the prior art. In such current drawn on one leg (or several legs) of a power circuit 125 is measured with a current sensing device 162 which emits a voltage that is proportional to the current flowing through that leg or legs of the power circuit 125. This voltage is then compared to a reference voltage (V-REF) by a comparator 102 and the output of the comparator is connected to a control circuit 100 that controls a power switch 152 (e.g., transistor, FET, Triac, solid state switch, relay, reed relay). When the voltage becomes greater than the reference voltage (V-REF), the control circuit 100 signals the power switch 152 to disconnect one or more legs of power circuit 125 that go to the device. Some such electronic fuses/breakers have a reset 104, for example, a reset button or a timer, that resets the control circuit and, therefore, controls the power switch to reconnect the leg(s) of the power circuit 125, thereby reapplying power to the device. It should be noted that the electronic fuse/breaker of the prior art shown in FIG. 1 can be adjusted by adjusting the reference voltage (V-REF), but does not have the ability to monitor the protected device for a current usage profile and determine when the device is malfunctioning (e.g., locked up) based upon veering from the expected current usage profile.

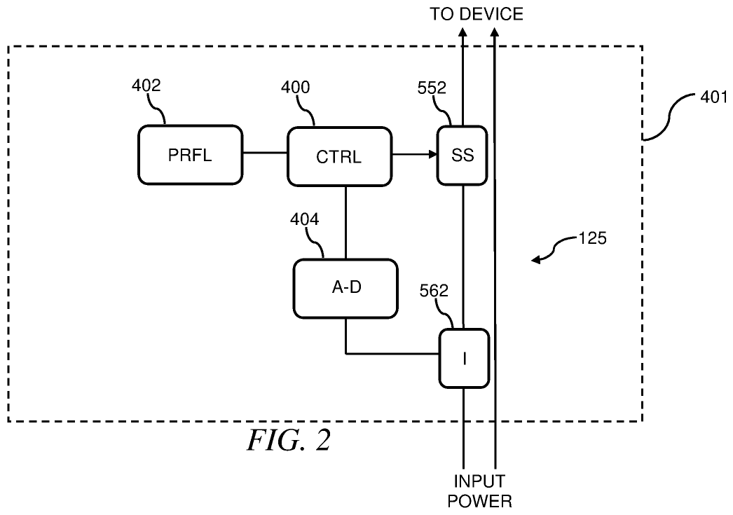

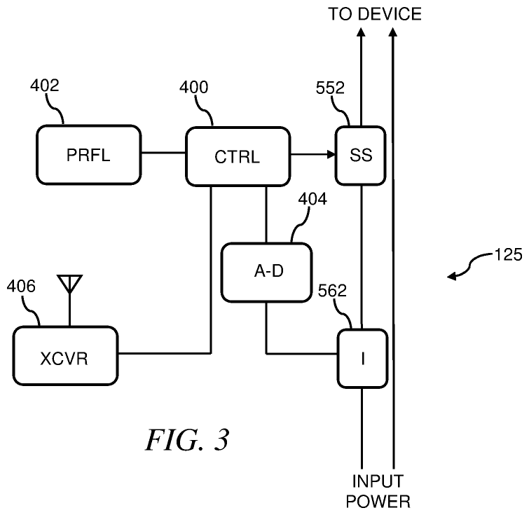

Referring to FIG. 2 and FIG. 3, schematic views of embodiments of the watchdog device interrupter are shown. In FIG. 2, an expected power profile 402 is provided (e.g., pre-programmed for the protected device) while in FIG. 3, a wireless receiver/transceiver 406 is included for modifying the expected power profile 402 and for other functions such as forcing a power cycle. In such, current drawn on one leg (or several legs) of a power circuit 125 is measured with a current sensing device 562 which emits a voltage (or current) that is proportional to the current flowing through that leg or legs of the power circuit 125. Although an analog system that performs in a similar way is fully anticipated, a digital system is shown for clarity and simplicity. The voltage (or current) representing the current flowing through the leg(s) if the power circuit 125 is converted to digital (e.g., by an analog-to-digital converter 404 or similar functionality) and provided as an input to a control circuit or controller 400. The controller 400 has an expected power profile 402 (e.g., stored in a memory of the controller 400) that describes the expected power consumption profile of the protected device. The expected power profile 402 is, for example, a series of data points that describe the expected power consumption of the protected device, either in digital or analog form. In analog form, a series of resistors and capacitors are used to define the expected profile. In digital form, groups of bits (or bytes) are used to define the expected power profile 402. For example, a first set of bits in the digital version of the expected power profile defines an expected power consumption range (e.g., 40 mA to 50 mA) and is followed by another set of bits that defines an amount of time that this amount of power consumption should last (e.g., two minutes). Sets of bits are also anticipated to indicate looping, so an example power profile might be a continuous repetition of {5 repetitions of 10 seconds of 40-50 mA followed by 2 seconds of 300-325 mA} followed by 300 seconds of 10-15 mA.

The controller 400 monitors the digital version of the power consumption of the device (from the analog-to-digital converter 404) and synchronizes to the power consumption to the expected power profile 402, then, after syncing. The controller 400 compares the power consumption to the expected power profile 402. When the controller 400 finds that the device is not conforming to the expected power profile 402, the controller 400 signals a power switch 552 (e.g., transistor, FET, triac, solid state switch, relay, reed relay) to disconnect one or more legs of power circuit 125 that provide power to the device. After a predetermined period of time (e.g., a fixed time period or a variable time period as defined in the expected power profile), the controller 400 signals the power switch 552 (e.g., transistor, FET, Triac, solid state switch, relay, reed relay) to reconnect one or more legs of power circuit 125 to provide power to the device. Assuming the device has locked up, this power cycle will reset the device. If this power cycle does not properly reset the device (e.g., the controller 400 cannot sync to the expected power profile 402 after the power cycle), in some embodiments, the controller 400 declares that the device is malfunctioning. In embodiments having an interface to an external system (e.g., a transceiver 406), when the controller 400 declares that the device is malfunctioning, a signal is sent to an external system to warn of the failed device.

In the watchdog device interrupter of FIG. 2, the expected power profile 402 is predefined, for example, a set of resistors and capacitors that define the expected power profile 402 or a set of bits in a memory (e.g., flash memory, battery-backed memory, read-only memory) that are preset with expected power profile 402.

In the watchdog device interrupter of FIG. 3, the expected power profile 402 is configurable, for example, a set of bits in a memory (e.g., flash memory, battery-backed memory, read-only memory) that are preset with an expected power profile 402 that are modified or set by the controller 400 upon receiving commands (e.g., though a wired interface or through a wireless interface as shown using a receiver or transceiver 406. In addition, having this wired or wireless interface, a remote system has the ability not only to set or change the expected power profile 402, but, in some embodiments, the remote system is able to manually power cycle the protected device (e.g., signal the power switch 552 to disconnect, then reconnect power) or to control hours of operation of the protected device (e.g., signal the power switch 552 to disconnect power from 8:00P M to 7:30A M).

Note that the embodiments shown include a watchdog device interrupter with a controller 400 that monitors and controls one protected device, it is fully anticipated that a single controller 400 perform the same or similar functions for multiple devices. Also, there is no restriction as to the type of power circuit 125 that is monitored and interrupted. The watchdog device interrupter is anticipated to work with any type of power circuit 125 such as a direct current (DC) power circuit 125, single phase alternating current, multiple phase alternating current, etc. For some types of power circuits 125 (e.g., two phase, three phase), the watchdog device interrupter has multiple current sensing devices 562, one for each phase of the power circuit 125.

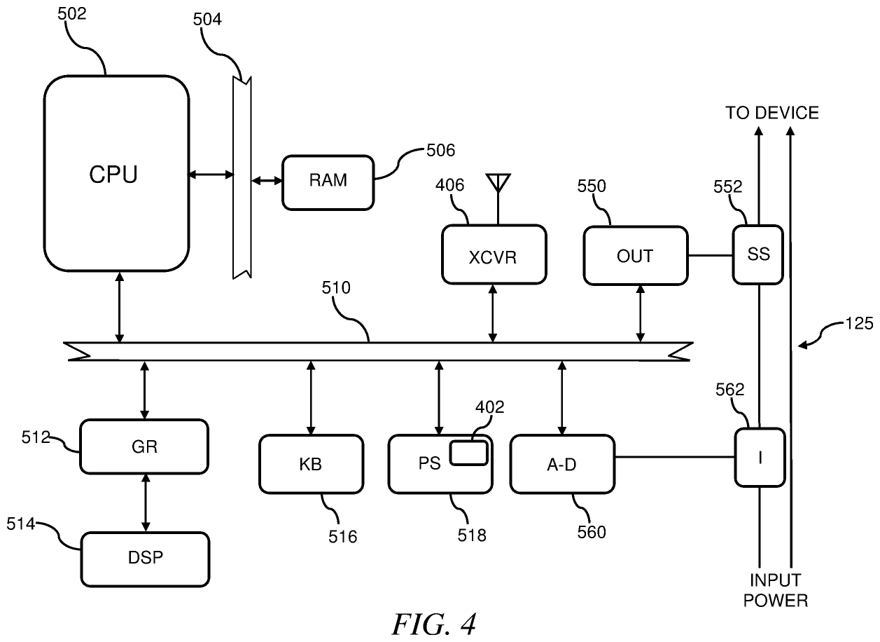

FIG. 4 illustrates a schematic view of another embodiment of the watchdog device interrupter. Note that the watchdog device interrupter is shown in an optional enclosure 401 in this view.

In this embodiment, a processor 502 has a memory 506 (e.g., random-access memory) accessed through any known configuration, a memory bus 504 being shown. The processor 502 is connected to an input/output bus 510. In some embodiments, a graphics controller 512 and display 514 are interfaced to the input/output bus 510. Also, in some embodiments, a keyboard 516 or other input device is interfaced to the input/output bus 510. Some form of persistent storage 518 is interfaced to the processor 502 (e.g., through the memory bus 504, input/output bus 510, of internal to the processor 502). The persistent storage is for storing data/software such as program instructions, data, and the expected power profile 402.

Current drawn on one leg (or several legs) of a power circuit 125 is measured with a current sensing device 562 which emits a voltage (or current) that is proportional to the current flowing through that leg or legs of the power circuit 125. The voltage (or current) representing the current flowing through the leg(s) if the power circuit 125 is converted to digital (e.g., by an analog-to-digital converter 560 or similar functionality) and provided as an input to the processor 502 (e.g., directly connected to an input of the processor 502 or through the input/output bus 510). The persistent storage 518 has an expected power profile 402 of the protected device. The expected power profile 402 is, for example, a series of data points that describe the expected power consumption of the protected device in digital form. In such, groups of bits (or bytes) are used to define the expected power profile 402. For example, a first set of bits in the digital version of the expected power profile defines an expected power consumption range (e.g., 40 mA to 50 mA) and is followed by another set of bits that defines an amount of time that this amount of power consumption should last (e.g., two minutes). Sets of bits are also anticipated to indicate looping, so an example power profile might be a continuous repetition of {5 repetitions of 10 seconds of 40-50 mA followed by 2 seconds of 300-325 mA} followed by 300 seconds of 10-15 mA.

Software running on the processor 502 causes the processor 502 to monitor the digital version of the power consumption of the protected device (from the analog-to-digital converter 560) and synchronizes to the measured power consumption based upon the expected power profile 402, then, after syncing, the software causes the processor 502 to compare the power consumption to the expected power profile 402. When the software running on the processor 502 finds that the protected device is not conforming to the expected power profile 402, the software causes the processor 502 to signal a power switch 552 (e.g., transistor, FET, Triac, solid state switch, relay, reed relay) to disconnect (e.g., interrupt) one or more legs of power circuit 125 that provide power to the protected device (e.g., through an output port 550). After a predetermined period of time (e.g., a fixed time period or a variable time period as defined in the expected power profile), the software causes the processor 502 to signal the power switch 552 (e.g., transistor, FET, Triac, solid state switch, relay, reed relay) to reconnect one or more legs of power circuit 125 to provide power to the protected device. Assuming the protected device has locked up, this power cycle will reset the protected device. If this power cycle does not properly reset the protected device (e.g., the software cannot cause the processor 502 to synchronize to the expected power profile 402 after the power cycle), in some embodiments, the software causes the processor 502 to declare that the protected device is malfunctioning. In embodiments having an interface to an external system (e.g., an optional transmitter or transceiver 406), when the software causes the processor 502 to declare that the protected device is malfunctioning, the software causes the processor 502 to send a signal to an external system to warn of the failed protected device.

In some embodiments having the optional transmitter or transceiver 406, the remote system is able to manually power cycle the protected device (e.g., signal the power switch 552 to disconnect, then reconnect power) or to control hours of operation of the protected device (e.g., signal the power switch 552 to disconnect power from 8:00P M to 7:30A M) by sending a command to the transceiver 406 and upon receiving the command, the software causes the processor 502 to take action based upon the command, for example, to update the expected power profile 402 or to signal the power switch 552 to disconnect.

Note that the embodiments shown include a watchdog device interrupter with a processor 502 configured to monitor and control one protected device, it is fully anticipated that the processor 502 perform the same or similar functions for multiple devices. Also, there is no restriction as to the type of power circuit 125 that is monitored and interrupted. The watchdog device interrupter is anticipated to work with any type of power circuit 125 such as a direct current (DC) power circuit 125, single phase alternating current, multiple phase, alternating current, etc. For some types of power circuits 125 (e.g., two phase, three phase), the watchdog device interrupter has multiple current sensing devices 562, one for each phase of the power circuit 125 and/or a power switch 152 for each phase of the power circuit 125 or a power switch 152 that is a single relay with multiple sets of contacts, each configured to open one phase of the power circuit.

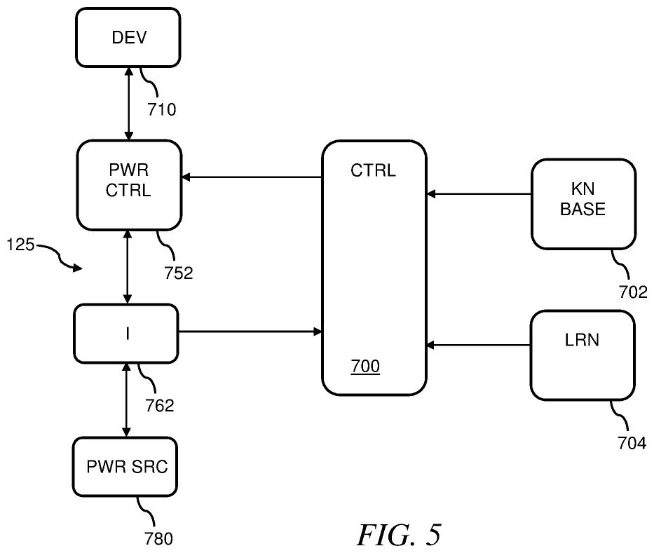

FIG. 5 illustrates a block diagram of an embodiment of the watchdog device interrupter with learning. In this embodiment, a controller 700 (e.g., logic or a processor) receives a signal from a current measuring device 762 that is proportional to the current flowing through the power circuit 125 (e.g., a digital signal proportional to the current) from a power source 780 going to a protected device 710. During a learning mode, the controller 700 monitors the current flowing through the power circuit 125 and learns the power usage profile of the protected device 710, storing knowledge about the power usage profile of the protected device 710 in a knowledge base 702. After the learning mode, the controller 700 monitors the current flowing through the power circuit 125 as compared to the knowledge base 702 and when the current flowing through the power circuit 125 veers from that of the knowledge base 702, the controller 700 signals the power switch 752 to disconnect power going to the protected device 710, then, after a predetermined or learned period of time, the controller 700 signals the power switch 752 to reconnect power going to the protected device 710. This power-cycle is intended to restart the protected device 710 as above. In some embodiments, a learn input 704 is provided to initiate the learning mode. The learn input is, for example, a switch input or a command received by way of a wireless transceiver or wired interface.

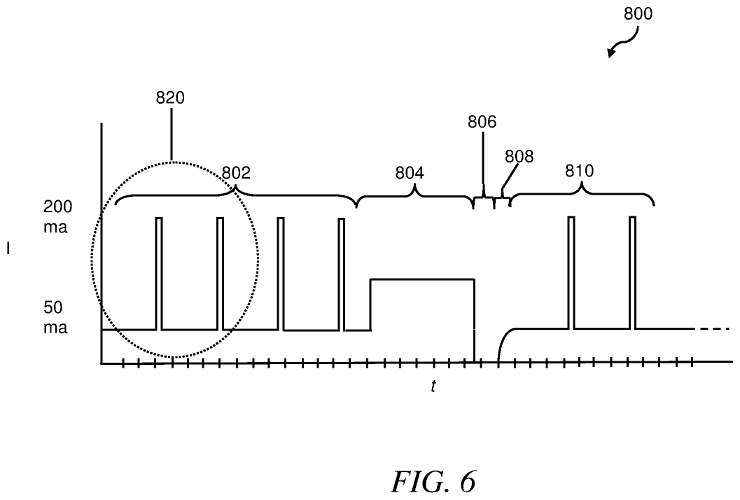

FIG. 6 illustrates a graph 800 of an exemplary protected device's current measurement over time showing the operation of an embodiment of the watchdog device interrupter with learning. In this, the protected device 710 has a longer period of low current (e.g., 50 mA when idle) than a short spike of a higher current (e.g., 200 mA when transmitting). This is monitored by the controller 700 during the learning period 820 and recorded in the knowledge base 702 (note that the learning period 820 is shown to be very short for clarity and brevity reasons). During an initial time 802 that includes the learning period, the protected device 710 exhibits the expected power profile. Next, something happens to the protected device 710 and a different power profile 804 is exhibited, for example, a constant current measurement of 100 mA. The controller 700 recognizes that this different power profile 804 is different than that expected by the knowledge base 702 and disconnects power to the protected device 710, resulting in a short period of zero power consumption 806. The controller, after a fixed or preset delay, reconnects power to the protected device 710 and the protected device reinitializes during a short period 808 that is ignored by the controller 700. Next, the protected device resumes normal operation with the continued power profile 810.

It should be noted that after learning, in some embodiments, the controller 700 continually learns and updates the knowledge base 702 for the protected device 710. For example, using the graph 800, as component of the protected device 710 age or as ambient temperatures around the protected device 710 change, so does the power usage of the protected device 710. In such embodiments, the controller 700 monitors these changes (e.g., as temperatures rise, the 200 mA power levels increase to 220 mA) and adjusts the knowledge base 702 accordingly.

In some embodiments, the watchdog device interrupter is external to the protected device, for example, in a separate enclosure. In some other embodiments, the watchdog device interrupter is integrated into the protected device, having logic and/or a processor that is separate and distinct from an logic or processor of the device.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A watchdog device interrupter comprising:
a controller;
means for sensing a current flowing to a protected device;
means for interrupting power to the protected device;
an expected power profile of the protected device, the expected power profile interfaced to the controller; and
the controller monitors the current flowing to the protected device over a period of time and when the current flowing to the protected device over the period of time differs from the expected power profile, the controller signals the means for interrupting power to interrupt power to the protected device for an interval.

2. The watchdog device interrupter of claim 1, wherein the expected power profile is pre-programmed.

3. The watchdog device interrupter of claim 1, wherein the controller learns the expected power profile from the means for sensing the current flowing to the protected device over a period of time.

4. The watchdog device interrupter of claim 1, wherein the expected power profile is stored in a memory of the controller.

5. The watchdog device interrupter of claim 1, wherein the controller signals the means for interrupting the power to interrupt power to the protected device for a predetermined period of time before reconnecting the power.

6. A method of monitoring and resetting a protected device, the method comprising:
sensing a current flowing to a protected device over a time period;
comparing the current flowing to the protected device over the time period; and
when the current flowing to the protected device over the time period differs from an expected power profile for the protected device, interrupting power going to the protected device.

7. The method of claim 6, wherein the expected power profile is pre-programmed.

8. The method of claim 6, further comprising learning the expected power profile from the protected device.

9. The method of claim 8, further comprising updating the expected power profile by further learning during operation of the protected device.

10. The method of claim 6, wherein the interrupting of the power to the protected device is for a predetermined period of time before reconnecting the power.

11. A system for monitoring and resetting a protected device, the system comprising:
a processor having a memory;
a current sensing device is interfaced to the processor, the current sensing device measures current flowing to the protected device and provides a measurement of the current flowing to the protected device to the processor;
a power switch controlled by the processor, the power switch controlling a flow of power to the protected device;
an expected power profile of the protected device, the expected power profile stored in the memory; and
software running on the processor causes the processor to monitor the current flowing to the protected device over a period of time and when the current flowing to the protected device over the period of time differs from the expected power profile, the software running on the processor causes the processor to interrupt power to the protected device.

12. The system of claim 11, wherein the expected power profile is pre-programmed.

13. The system of claim 11, wherein the software running on the processor causes the processor to learn the expected power profile of the protected device over a period of time.

14. The system of claim 11, wherein the power switch is a relay.

15. The system of claim 11, wherein the power switch is a transistor.

16. The system of claim 11, wherein the power switch is a Triac.

17. The system of claim 11, wherein the software running on the processor causes the processor to interrupt power to the protected device for a predetermined period of time before reconnecting the power.
